(19) United States
(12) Patent Application Publication
(10) Pub. No.: US 2009/0123795 A1
(43) Pub. Date: May 14, 2009

(54) Condensate drainage subsystem for an electrochemical cell system

(76) Inventors: Christopher J. Chuah, P.E., Clifton Park, NY (US); John Van Heertum, Latham, NY (US)

Correspondence Address: TROP, PRUNER & HU, P.C., 1616 S. VOSS ROAD, SUITE 750, HOUSTON, TX, 77057-2631, US

(21) Appl. No.: 11/985,043

(22) Filed: Nov. 13, 2007

(51) Int. Cl. H01M 8/06

(52) U.S. Cl. 429/17; 429/13; 429/21

(57) ABSTRACT

A technique that is usable with an electrochemical cell includes in response to a power producing mode of the cell, communicating a cathode exhaust that is provided by the cell through a liquid trap sealing device. The technique includes in response to an pumping mode of the cell, isolating the liquid trap sealing device.

### BACKGROUND

The invention generally relates to a condensate drainage subsystem for an electrochemical cell system.

A fuel cell is an electrochemical device that converts chemical energy directly into electrical energy. For example, one type of fuel cell includes a proton exchange membrane (PEM) that permits only protons to pass between an anode and a cathode of the fuel cell. Typically PEM fuel cells employ sulfonic-acid-based ionomers, such as Nafion, and operate in the 500 Celsius (C) to 75° C. temperature range. Another type of fuel cell employs a phosphoric-acid-based polybenziamidazole, PBI, membrane that operates in the 1500 to 2000 temperature range. At the anode, diatomic hydrogen (a fuel) is reacted to produce protons that pass through the PEM. The electrons produced by this reaction travel through circuitry that is external to the fuel cell to form an electrical current. At the cathode, oxygen is reduced and reacts with the protons to form water. The anodic and cathodic reactions are described by the following equations:

Anode: H₂→2H⁺+2e⁻ Equation 1

Cathode: O₂+4H⁺+4e⁻→2H₂O Equation 2

The PEM fuel cell is only one type of fuel cell. Other types of fuel cells include direct methanol, alkaline, phosphoric acid, molten carbonate and solid oxide fuel cells.

A typical fuel cell has a terminal voltage near one volt DC. For purposes of producing much larger voltages, several fuel cells may be assembled together to form an arrangement called a fuel cell stack, an arrangement in which the fuel cells are electrically coupled together in series to form a larger DC voltage (a voltage near 100 volts DC, for example) and to provide more power.

The fuel cell stack may include flow plates (graphite composite or metal plates, as examples) that are stacked one on top of the other, and each plate may be associated with more than one cell of the stack. The plates may include various surface flow channels and orifices to, as examples, route the reactants and products through the fuel cell stack. Electrically conductive gas diffusion layers (GDLs) may be located on each side of a catalyzed PEM to form the anode and cathodes of each fuel cell. In this manner, reactant gases from both the anode and cathode flow-fields may diffuse through the GDLs to reach the catalyst layers.

In general, a fuel cell is an electrochemical cell that operates in a forward mode to produce power. However, the electrochemical cell may be operated in a reverse mode in which the cell produces hydrogen and oxygen from electricity and water. More specifically, an electrolyzer splits water into hydrogen and oxygen with the following reactions occurring at the anode and cathode, respectively:

Anode: 2H₂O→O₂+4H⁺+4e⁻ Equation 3

Cathode: 4H⁺+4e⁻→2H₂ Equation 4

An electrochemical cell may also be operated as an electrochemical pump. For example, the electrochemical cell may be operated as a hydrogen pump, a device that produces a relatively pure hydrogen flow at a cathode exhaust of the cell relative to an incoming reformate flow that is received at an anode inlet of the cell. In general, when operated as an electrochemical pump, the cell has the same overall topology of the fuel cell. In this regard, similar to a fuel cell an electrochemical cell that operates as a hydrogen pump may contain a PEM, gas diffusion layers (GDLs) and flow plates that establish plenum passageways and flow fields for communicating reactants to the cell. However, unlike the arrangement for the fuel cell, the electrochemical pump cell receives an applied voltage, and in response to the received current, hydrogen migrates from the anode chamber of the cell to the cathode chamber of the cell to produce hydrogen gas in the cathode chamber. A hydrogen pump may contain several such cells that are arranged in a stack.

### SUMMARY

In an embodiment of the invention, a technique that is usable with an electrochemical cell includes in response to a power producing mode of the cell, communicating a cathode exhaust stream that is provided by the cell through a liquid trap sealing device. The technique includes in response to a pumping mode of the cell, isolating the liquid trap sealing device.

In another embodiment of the invention, a technique that is usable with an electrochemical cell stack includes during a power producing mode of the stack, communicating reactants through the stack to cause the stack to produce power and provide a first exhaust stream at a cathode outlet of the stack. The technique includes routing the first exhaust stream through a liquid trap sealing device and using the liquid trap sealing device to remove condensate from the first exhaust stream. The technique includes during a pumping mode of the stack, communicating a relatively lean fuel stream through an anode chamber of the stack, isolating the liquid trap sealing device and providing power to the stack to cause the stack to provide a second exhaust stream at the cathode outlet. The second exhaust stream is relatively richer in fuel than the relatively lean fuel stream.

In yet another embodiment of the invention, an electrochemical cell system includes a fuel source, an oxidant source, a power source, an electrochemical cell stack, a liquid trap seal and a control subsystem. The electrochemical cell stack is adapted to during a power producing mode of the stack, produce a first cathode exhaust stream and produce power in response to reactants being provided by the fuel and oxidant sources. The electrochemical cell stack is adapted to during a pumping mode, produce a relatively rich fuel, second cathode exhaust stream in response to a relatively lean fuel stream that is provided by the fuel source and power that is provided by the power source. The liquid trap sealing device removes condensate from the first cathode exhaust stream, and the control subsystem isolates the liquid trap sealing device in response to the pumping mode.

Advantages and other features of the invention will become apparent from the following drawing, description and claims.

### BRIEF DESCRIPTION OF THE DRAWING

FIG. 1 is a schematic diagram of an electrochemical cell system that contains a condensate drainage subsystem according to an embodiment of the invention.

FIG. 2 is a flow diagram depicting a technique to use a liquid sealing device with a dual mode electrochemical cell stack according to an embodiment of the invention.

FIG. 3 is a schematic diagram illustrating an alternative design for a condensate drainage subsystem according to another embodiment of the invention.

FIG. 4 is a cross-sectional view of a water trap according to an embodiment of the invention.

### DETAILED DESCRIPTION

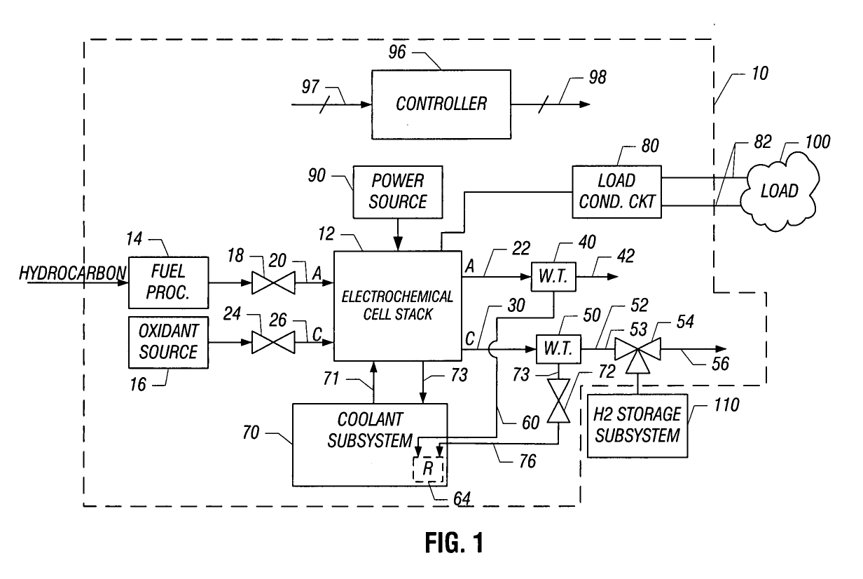

Referring to FIG. 1, an electrochemical cell system 10 (a residential energy station, for example) in accordance with embodiments of the invention includes a dual mode electrochemical cell stack 12 that operates in one of two modes: 1.) a power producing mode in which the stack 12 functions as a fuel cell stack to produce electrical power for auxiliary power devices of the system and possibly power for an external load 100 (a residential load, a commercial load, an AC power grid, etc.); and 2.) a pumping mode in which the stack 12 functions as an electrochemical pump to purify a relatively lean fuel flow to produce a purified fuel flow (a hydrogen flow, for example), which may be stored in a storage subsystem.

For the examples that are described herein, the electrochemical cell stack 12 is a stack that contains PEM membranes and receives a hydrocarbon reformate (50% hydrogen, for example) as a fuel reactant and air as an oxidant reactant during the power producing mode of the stack 12. During the pumping mode, the stack 12 purifies the reformate flow to produce a relatively pure hydrogen flow that may stored in the storage subsystem 110. It is noted, however, that the stack 12 may contain non-PEM fuel cells; may produce power in response to a fuel other than a fuel that contains hydrogen; and may purify a gas other than hydrogen, in accordance with other embodiments of the invention.

Turning to the more specific details, in the power producing mode, the stack 12 receives an incoming fuel flow (reformate, for example) and an incoming oxidant flow (air, for example) from a fuel processor 14 and an oxidant source 16, respectively. The fuel processor 14 reforms a hydrocarbon (liquefied petroleum gas, natural gas, etc.) to produce the reformate flow that is provided to an anode inlet 20 of the stack 12. The incoming fuel flow is communicated through the anode chamber of the cell stack 12 to promote electrochemical reactions inside the stack pursuant to Eqs. 1 and 2 for purposes of producing electrical power. The anode flow through the stack 12 produces an anode exhaust flow at an anode outlet 22 of the stack 12. It is noted that all, part or none of the anode exhaust flow may be recirculated to the anode inlet 20, depending on the particular embodiment of the invention. Furthermore, the fuel cell system may include an exhaust recirculation blower to recirculate some or all of the anode exhaust gas to the anode inlet 20. Additionally, the exhaust of the anode chamber of the stack 12 may be closed off (and thus “dead ended” or “dead headed”) except for a purge or bleed flow during the power producing mode, in some embodiments of the invention. Thus, many variations are contemplated and are within the scope of the appended claims.

The oxidant source 16, in the power producing mode, furnishes an oxidant flow that is received at a cathode inlet 26 of the stack 12 and propagates through the cathode chamber of the stack 12. The oxidant flow in the stack 12 promotes the electrochemical reactions pursuant to Eqs. 1 and 2 to produce electrical power and produces a cathode exhaust flow that appears at a cathode outlet 30 of the stack 12.

It is noted that the incoming fuel and oxidant flows to the stack 12 may pass through various control valves, such as exemplary valves 18 and 24, respectively.

For purposes of conditioning the power that is generated by the stack 12 into the appropriate AC and/or DC voltages for the loads, the system 10 includes load conditioning circuitry 80, which may include various DC-to-DC converters, DC-to-AC converters, inverters, etc. The power that is conditioned by the load conditioning circuitry 80 may be communicated to the load 100 via power supply terminals 82. In some embodiments of the invention, the circuitry 80 may provide and condition the power that is provided to the stack 12 during the pumping mode, thereby taking on the function of a power source 90, or the power source 90 may be separate from the circuitry 80 and activated during the pumping mode as further described below.

In the pumping mode, the stack 12 does not produce electrical power, but rather, power is provided to the stack 12 by the power source 90, which may be, as examples, a bank of storage batteries, a converter that receives power from the AC grid, etc. Regardless of its particular form, the power source 90 provides a stack current to promote the pumping. In the pumping mode, the stack 12 purifies the relatively lean fuel flow that is provided by the fuel processor 14. For example, the incoming fuel flow to the stack 12 may be reformate that may be, as an example, approximately fifty percent hydrogen. In response to the incoming lean fuel flow and the stack current that is provided by the power source 90, the electrochemical cell stack 12 promotes electrochemical cell reactions to cause hydrogen ions to propagate across the cell membranes to produce a relatively pure hydrogen flow that exits the stack 12 at the cathode outlet 30. Thus, in the pumping mode, the cathode exhaust stream that is provided by the stack 12 is a relatively pure form of hydrogen (i.e., a relatively rich fuel flow). It is noted that during the pumping mode, the cathode inlet 26 to the stack 12 is closed off (via the closure of the valve 24, for example). It is noted that the cathode exhaust stream may be further purified in the pumping mode via a pressure swing absorber (PSA), in accordance with some embodiments of the invention.

In the power producing mode, the reactant exhaust streams that are provided by the stack 12 contain a significant amount of water, as water generally accumulates in the anode and cathode chambers of the stack 12 during power production. For purposes of removing this water, the electrochemical cell system 10 includes a condensate drainage subsystem, a subsystem that includes liquid trap sealing devices, or water traps 40 and 50.

The water trap 40, 50 is designed to provide a liquid trap seal. More specifically, the water trap 40, 50 is designed to collect condensate from a particular reactant exhaust stream; communicate the collected condensate to an associated condensate drain line; use collected condensate to provide a liquid seal to seal off the associated condensate drain line from the gas in the exhaust stream if a sufficient level of collected condensate is present; and provide a mechanical seal (a float-based seal, for example) that prevents gas from the exhaust stream from entering the associated condensate drain line if a sufficient level of collected condensate is not available to provide a sufficient liquid seal.

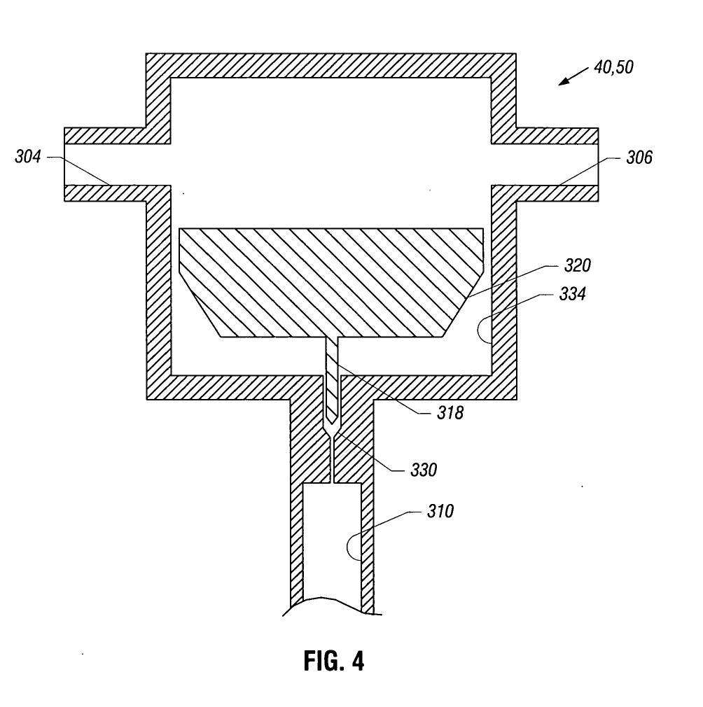

More specifically, referring to FIG. 4, in accordance with some embodiments of the invention, the water trap 40, 50 has three ports: an exhaust stream inlet port 304; an exhaust stream output port 306; and a condensate drain line port 310 that is connected to the associate condensate drain line. The water trap 40, 50, in general, allows communication between the exhaust stream inlet 304 and outlet 306 ports; and the condensate outlet port 310 is at the bottom of a condensate collection reservoir 334. For the example depicted in FIG. 4, the water trap 40, 50 has a needle 318 and float 320 arrangement, which ensures that a predetermined level of condensate exists in the condensate reservoir 334 of the trap 40, 50 before the trap 40, 50 opens communication between the interior of the trap 40, 50 (in communication with the inlet port 304 and outlet port 306) and the condensate drain line port 310.

The float 320 and needle 318 arrangement is constructed to ideally mechanically seal off the condensate drain line port 310 from the interior space of the water trap 40, 50 if the level of collected condensate in the condensate reservoir 334 is insufficient to form a liquid seal. Thus, an insufficient water level (i.e., a low water level or no water) allows the float 320 to descend so that the needle 318 seats in a valve seat 330 that controls fluid communication between the interior space of the water trap 40, 50 and the port 310 so that this mechanical seal isolates the ports 304 and 306 from the port 310. However, if the level of collected condensate in the condensate reservoir 334 is sufficient to provide a liquid seal between the reactant gas flow and the condensate drain line 310, then the water level is sufficient to exert a force on the float 320 to lift the needle 318 out of the valve seat 330 to therefore allow the communication of condensate from the condensate reservoir port 334 and into the condensate drain line port 310.

Referring back to FIG. 1, in general, the water trap 40 has an exhaust stream inlet port that is connected to the anode outlet 22 and a condensate drain line outlet port that is connected to an associated condensate drain line 60; and the water trap 50 has an exhaust stream inlet port that is connected to the cathode outlet 30 and a condensate drain line port that is coupled through a line 75 and a valve 72 to an associated condensate drain line 76.

During the power producing mode of the stack 12, the water trap 40 collects condensate from the anode exhaust stream and routes the collected condensate to the associated condensate drain line 60, which communicates the condensate to a coolant reservoir 64. The relatively drier anode exhaust stream exits the water trap 40 and is routed to an outlet line 42, which may be connected to a flare or oxidizer; may be vented to ambient; may be routed back to the anode inlet stream; etc., as just a few examples.

Similarly, during the power producing mode, the water trap 50 collects condensate from the cathode exhaust stream and routes the collected condensate to the line 75 so that the condensate passes through the valve 72 (which is open, as further described below) and into the condensate drain line 76. The condensate drain line 76, in turn, routes the condensate into the coolant reservoir 64. The relatively drier cathode exhaust stream exits the water trap 50 and is routed to an outlet line 52. The relatively drier cathode exhaust may then be communicated through a three-way valve 54 to an outlet 56, where the cathode exhaust may be vented to ambient; routed back to the fuel processor 14; routed to the cathode inlet 26, routed to a flare or oxidizer; etc., as just a few examples.

As an example, the reservoir 64 may be a reservoir of a coolant subsystem 70 of the electrochemical cell system 10. In general, the coolant subsystem 70 may circulate a coolant, such as water, through the stack 12 by using the reservoir 64 as a pump for the coolant flow, which is pumped to a coolant inlet 71 by the subsystem 70 and circulates through the coolant flow channels of the stack 12 to absorb thermal energy from the stack 12 to produce a heated water/steam flow that exits the stack 12 at a coolant outlet 73 of the stack 12. The coolant subsystem 70 condenses water from the returning coolant flow, and this water may be communicated into reservoir 64.

The pressure in the cathode exhaust stream significantly varies, depending on whether the stack 12 is operating in the power producing mode or the pumping mode. As a non-limiting example, the pressure of the cathode exhaust stream may be approximately 2 pounds per square inch (psi) for the power producing mode and may be approximately 120 psi for the pumping mode. Because the mechanical seal that is provided by the water trap 50 may potentially be subject to both cathode exhaust streams (i.e., a lower pressure cathode exhaust stream for the power producing mode and a higher pressure cathode exhaust stream for the pumping mode), the mechanical seal could be designed to withstand the higher pressure (i.e., 120 psi, as an example) in order to prevent a gas leak through the water trap 50 (i.e., a leak that allows gas to flow into the drain line 76) during the pumping mode. However, such a design may require a more costly and/or complex design for the water trap 50.

In accordance with embodiments of the invention, instead of designing the water trap 50 to accommodate the higher pressure cathode exhaust stream that is present in the pumping mode, the water trap 50 is designed for the lower pressure cathode exhaust stream (present in the power producing mode), and the water trap 50 is isolated during the pumping mode for purposes of preventing leaks through the water trap's mechanical seal.

The isolation of the mechanical seal of the water trap 50 takes advantage of the recognition that the stack 12 does not produce excess water in the cathode exhaust stream during the pumping mode. In other words, the stack 12 does not, via electrochemical reactions, produce water in the cathode chamber during the pumping mode. Instead, in the pumping mode, the hydrogen is electrochemically pumped across the membranes, and condensate is only produced by the stack 12 on the anode side. The anode exhaust stream during the pumping mode does not, however, have the relatively high pressure that is exhibited by the cathode exhaust stream. Therefore, the water trap 40 may also be constructed to withstand a relatively low pressure.

FIG. 1 depicts one of many possible arrangements to isolate the water trap 50 during the pumping mode, in accordance with some embodiments of the invention. As depicted in FIG. 1, the valve 72 (a solenoid valve, for example) controls communication between the line 75 (in communication with the condensate drain line port of the water trap 50) and the condensate drain line 76. During the power producing mode, a controller 96 of the system 10 causes the valve 72 to remain open to establish communication between the condensate outlet 75 and the condensate drain line 76. However, in the pumping mode, the controller 96 closes the valve 72 to isolate the water trap 50 from the condensate drain line 76 so that cathode exhaust gas does not breach the mechanical seal of the water trap 50 (which is designed for a lower operating pressure) and a flow into the condensate drain line 76.

The advantages of isolating the water trap 50 during the pumping mode and designing the water trap 50 to mechanically seal at a lower operating pressure may include one or more of the following. The need for a high pressure condensate float is eliminated. Hydrogen production efficiency is increased. Hydrogen emissions from the float are eliminated, thereby improving safety.

The controller 96 represents one or more microprocessors and/or microcontrollers, in accordance with some embodiments of the invention. In general, the controller 96 controls the overall operations of the electrochemical cell system 10 and thus, has various output terminals 98 that operates the motors, valves, subcontrollers, the fuel processor 74, coolant subsystem 70, load conditioning circuitry 80, power source 90, etc. of the system 10. Thus, the controller 96 is constructed to configure the electrochemical cell system 10 for the power producing mode and likewise, configure the system 10 for the pumping mode by operating the appropriate control systems. The controller 96 also has various input terminals 97 for receiving commands, monitoring sensed parameters, monitoring voltages, currents, operating conditions, etc., of the electrochemical cell system 10.

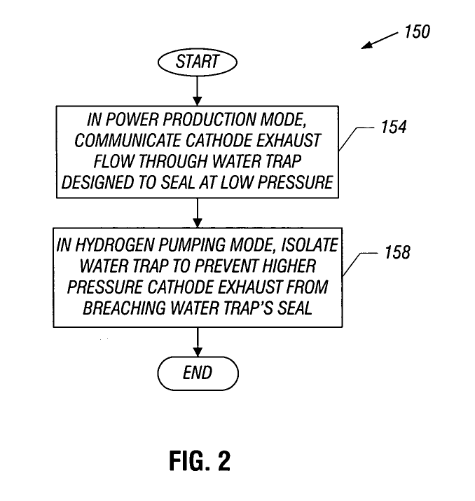

To summarize, a technique 150 that is depicted in FIG. 2 may be used in accordance with some embodiments of the invention. Pursuant to the technique 150, a cathode exhaust is communicated through a water trap that is designed to seal at low pressure in a power producing mode of the stack 12, pursuant to block 154. Pursuant to block 158, in the pumping mode, the water trap is isolated to prevent higher pressure cathode exhaust from breaching the water trap's seal.

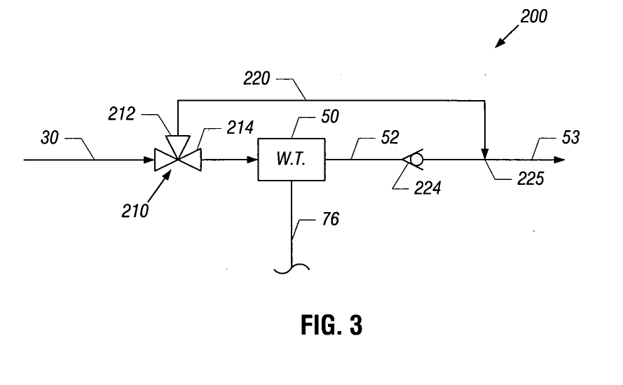

Other embodiments are contemplated and are within the scope of the appended claims. For example, referring to FIG. 3, in accordance with some embodiments of the invention, an alternative arrangement 200 may be used in connection with the condensate drain subsystem. Instead of isolating the water trap 50 by shutting off communication between the trap 50 and the condensate drain line, the water trap 50 may be isolated upstream. In this regard, a three-way valve 210 may be located upstream of the water trap 50 and may be connected to the cathode outlet 30 (see FIG. 1) of the stack 12. During the power producing mode of the stack 12, the controller 96 (see FIG. 1) operates the valve 210 to establish communication between the cathode outlet 30 and the exhaust stream inlet port of the water trap 50. Thus, during the power producing mode, the cathode exhaust passes through the water trap 50 and onto the communication line 53, and collected condensate is communicated from the water trap 50 to the condensate drain line 76.

During the pumping mode, the controller 96 controls the valve 210 to block communication between the cathode exhaust 30 and the exhaust gas inlet port of the water trap 50 and establish communication between the cathode outlet 30 and a junction 225 that is downstream of the water trap 50. In this regard, in the pumping mode, the valve 210 routes the cathode exhaust through a water trap bypass line 220 that is connected at the junction 225 to the communication line 53. A check valve 224 may be located between the gas exhaust outlet port of the water trap 50 and the junction 225 to isolate the port from the bypass flow. It is noted that FIGS. 1 and 3 are merely examples of some of the many possible subsystems to isolate the water trap 50 from the cathode exhaust stream during the pumping mode. Thus, many other variations are contemplated and are within the scope of the appended claims.

While the invention has been disclosed with respect to a limited number of embodiments, those skilled in the art, having the benefit of this disclosure, will appreciate numerous modifications and variations therefrom. It is intended that the appended claims cover all such modifications and variations as fall within the true spirit and scope of the invention.

What is claimed is:

1. A method usable with an electrochemical cell, comprising:
in response to a power producing mode of the cell, communicating a cathode exhaust provided by the cell through a liquid trap seal; and
in response to a pumping mode of the cell, isolating the liquid trap sealing device.

2. The method of claim 1, wherein the act of isolating the liquid trap sealing device comprises blocking communication through a liquid outlet of the device.

3. The method of claim 1, wherein the act of isolating the liquid trap sealing device comprises causing a cathode exhaust provided by the electrochemical cell to bypass the liquid trap sealing device.

4. The method of claim 1, wherein the liquid trap sealing device is adapted to seal against a relatively low gas pressure, and the isolating prevents a relatively higher pressure associated with a cathode exhaust provided by the electrochemical cell during the pumping mode from breaching a seal of the liquid trap sealing device.

5. The method of claim 1, wherein the act of isolating comprises operating at least one valve in response to the cell transitioning between the power production and electrochemical pumping modes of the cell.

6. The method of claim 1, wherein the act of isolating comprises isolating a mechanically-operated seal of the liquid trap sealing device.

7. A method usable with an electrochemical cell stack, comprising:
during a power producing mode of the stack, communicating reactants through the stack to cause the stack to produce power and provide a first exhaust stream at a cathode outlet of the stack;
routing the first exhaust stream through a liquid trap sealing device;
using the liquid trap sealing device to remove condensate from the first exhaust stream; and
during a pumping mode of the stack, communicating a relatively lean fuel stream through an anode chamber of the stack, isolating the liquid trap sealing device and providing power to the stack to cause the stack to provide a second exhaust stream at the cathode outlet, the second exhaust stream being relatively richer in fuel than said relatively lean fuel stream.

8. The method of claim 7, wherein the act of isolating the liquid trap sealing device comprises blocking communication through a liquid outlet of the device.

9. The method of claim 7, wherein the act of isolating the liquid trap sealing device comprises causing the second exhaust stream to bypass the liquid trap sealing device.

10. The method of claim 7, wherein the liquid trap sealing device comprises a mechanical seal adapted to form a seal against a relatively low gas pressure, and the isolating prevents a relatively higher pressure associated with the second exhaust stream from breaching a seal formed by the mechanical seal.

11. The method of claim 7, wherein the act of isolating comprises operating at least one valve in response to a transition between the power producing and pumping modes.

12. An electrochemical cell system, comprising:
a fuel source;
an oxidant source;
a power source;
an electrochemical cell stack adapted to:
during a power producing mode of the stack, produce a first cathode exhaust stream and produce power in response to reactants being provided by the fuel and oxidant sources, and
during a pumping mode, produce a fuel rich cathode exhaust stream in response to a fuel lean stream provided by the fuel source and power provided by the power source;
a liquid trap sealing device to remove condensate from the first cathode exhaust stream; and
a control subsystem to isolate the liquid trap sealing device in response to the electrochemical pumping mode.

13. The electrochemical cell system of claim 12, wherein the liquid trap sealing device is adapted to collect condensate from the first cathode exhaust stream, the system, further comprising:
a reservoir; and
a condensate communication line to communicate the condensate collected by the liquid trap seal to the reservoir,
wherein the control subsystem is adapted to block the communication of the condensate through the condensate communication line in response to the pumping mode.

14. The electrochemical cell system of claim 12, wherein the control subsystem is adapted to bypass the liquid trap sealing device in response to the pumping mode.

15. The electrochemical cell system of claim 12, wherein the liquid trap sealing device comprises a mechanical seal adapted to form a seal against a relatively low gas pressure, and the isolation of the liquid trap seal by the control subsystem prevents a relatively higher pressure associated with the fuel rich cathode exhaust stream from breaching a seal formed by the mechanical seal.

16. The electrochemical cell system of claim 12, wherein the control subsystem comprises at least one valve operated in response to a transition between the power producing and pumping modes.
